(19) United States
(12) Patent Application Publication
(10) Pub. No.: US 2020/0090143 A1
(43) Pub. Date: Mar. 19, 2020

(54) System, Method, and Apparatus for Online Content Platform and Related Cryptocurrency

(71) Applicant: Andrea Iervolino, Los Angeles, CA (US)

(72) Inventor: Andrea Iervolino, Los Angeles, CA (US)

(21) Appl. No.: 16/132,277

(22) Filed: Sep. 14, 2018

(51) Int. Cl. G06Q 20/06; G06Q 20/36; G06Q 30/02; H04L 9/06; H04L 29/06

(52) U.S. Cl. CPC G06Q 20/0658; G06Q 20/3672; G06Q 30/0214; G06Q 30/0215; G06Q 20/123; G06Q 30/0217; H04L 9/0637; H04L 63/0807; G06Q 30/0239

(57) ABSTRACT

A system, method, and apparatus for an online content platform and a related cryptocurrency may provide a blockchain-backed cryptocurrency and an online content platform, wherein users may be compensated in the cryptocurrency for the user's engagement with content provided on the online content platform. The cryptocurrency may be supported by a blockchain database distributed across one or more nodes. A user may also earn cryptocurrency when one or more users designated as a “friend” of the user interact with the content. The present invention may further comprise one or more additional blockchain-backed components, such as a Digital Rights Management tool.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to online content platforms and blockchain-powered cryptocurrencies, and more particularly, to a blockchain-powered social entertainment platform and connected cryptocurrency.

### BACKGROUND

Internet-based social networks are known, as are online content platforms. Yet, these systems, in isolation or in combination, treat the end user solely as a revenue source and thus exploit the content consumer. Moreover, many blockchain-based data management systems fail to provide a proprietary cryptocurrency that is tethered to the data's usage.

Attempts have been made to utilize blockchain databases to solve related problems. For example, U.S. Patent Application Publication No. 2018/0068091, incorporated herein by reference in its entirety, provides for a digital rights management platform wherein shadow versions of content's copyright information are stored on a blockchain ledger. Unfortunately, this disclosure fails to pair a cryptocurrency with the copyrighted content. Another attempt can be seen with respect to the disclosure of U.S. Pat. No. 9,595,934, also incorporated by reference in its entirety herein, which generally discloses a restricted-access ledger and a cryptocurrency transaction element. This disclosure, however, lacks a content-providing element or platform. Yet another example, U.S. Patent Application No. 2015/0371224, incorporated by reference in its entirety herein, discloses a cryptocurrency distribution system and related cryptowallet, but fails to provide for a connection with a content distribution blockchain.

A need remains therefore for a system, method, and apparatus that partners with users by paying them cryptocurrency in proportion to the amount of content-consumption for which they are directly or indirectly responsible.

### SUMMARY

The present disclosure is directed to a system, method, and apparatus for online content platform and related cryptocurrency, wherein a proprietary cryptocurrency is provided to users based on their consumption of provided content, as well as based on the consumption of content by the users' friends and friends of friends. In some embodiments, the cryptocurrency, an associated cryptocurrency ledger may be provided on a blockchain database backend. In some embodiments, the provided content as well as a provided content ledger, which in some embodiments may be a Digital Rights Management tool, may also be provided on a blockchain database backend. The cryptocurrency may be distributed to one or more cryptowallets associated with one or more users.

More specifically, the present invention comprises but is not limited to an online content platform having three core components: an Advertising Video on Demand (AVOD) component, a Social Media and User Management component, and at least one blockchain component. The online content platform may provide content with which a user may interact, such as social media, videos, music and chat, as well as reward users with cryptocurrency for engaging with the content.

The AVOD system may comprise three parts: a front-end part and two backend parts. The front-end part may comprise a video playback widget (for example a VOD Player, movie listing screen, or movie detail screen) that may comprise either new code or existing code with new templates. The front-end application may provide for a web application hosted on AWS server, an iOS App hosted on Apple App Store, an Android App hosted on Google Play, and other such applications. The AVOD first backend part may comprise an AVOD Content Management System and provide video content distribution network that may be hosted on the cloud and may also comprise either new code or existing code with new templates. The AVOD second backend part may comprise an advertising management and distribution network also comprising either new code or existing code with new templates.

The Social Media and User Management component may be made up of two parts: a front-end part and a backend part. The social media and user management front-end part may comprise a social widget where users may post comments, share, invite friends, provide insights, a user management widget that includes registration, login, logout, and an administration (or “admin”) console. The social media and user management front-end may be hosted on the cloud. The social media and user management backend may comprise a Social Media and User Management Content Management System that may comprise a new code base and/or application code and may be cloud-hosted.

The blockchain component, as described more fully elsewhere herein, may comprise at least two parts: a cryptocurrency and cryptocurrency ledger, and a Digital Rights Management tool.

In some embodiments, the proprietary cryptocurrency of the present invention may be supported by a blockchain database distributed across one or more nodes. A user may earn cryptocurrency (or cryptocurrency “tokens”) for interacting with the content, such as by viewing a video on the online content platform. A user may also earn cryptocurrency when the user's friends (i.e. other users referred to the present invention by the user) interact with the content. The present invention may also provide for a store within the online content platform wherein users may redeem their cryptocurrency for recognition, a real-world benefit, or other benefits. The online content platform may also analyze content to identify one or more products within the content that are for sale, and in some instances may assist a product provider in its advertising or a content viewer with obtaining the product. In some embodiments, products identified within the content may be obtainable using the cryptocurrency. The Digital Rights Management tool may record some or all information relating to the content, including rights, royalties, credit, and contracts, across one or more nodes in a blockchain database.

The online content platform may be configured to provide movies, television shows, short films, video clips, live action video, on-demand programming, live television, broadcast programming, cable broadcasts, special-interest programming, commercials, music, music videos, songs, ringtones, song snippets, video games, online games, celebrity news and gossip, sporting events, amateur videos, images, text, social media accounts, social media feeds, video moments, live event feeds, prose, poetry, fiction, audio books, images, augmented reality, virtual reality, interactive games, geogamified activities, and any other related type of content (collectively “content” or “content element(s)”).

The online content platform may act as a hub for the confluence of social network, video, music, and chat/messaging services. It may also provide, in some embodiments, a vertically-integrated social media platform that connects users to content and brands, and rewards them for their participation. In some embodiments, the present invention may provide content to users paid on a per-use basis such as a single use movie rental, a recurring basis such as a monthly fee for music streaming, or on a free basis such as a free chat service. In some embodiments, a user may create content and/or advertising for their content using the online content platform.

The online content platform may facilitate the flow of cryptocurrency between advertisers, content providers and producers, service providers, charitable entities, token holding non-banking institutions or companies, celebrities, corporations, banks, passive participants, and any other person or entity that is not an individual human user (collectively, “third parties”), as well as between one or more users and one or more third parties. It may also support geo-blocking.

### BRIEF DESCRIPTION OF THE DRAWINGS

FIG. 1 is a block diagram of a networked environment in which an exemplary embodiment of a system for online content platform and related cryptocurrency is implemented.

FIG. 2 illustrates an exemplary embodiment of a mobile device shown in FIG. 1.

FIG. 3 is a flowchart depicting an exemplary embodiment of a method for online content platform and related cryptocurrency.

FIG. 4 illustrates one or more elements of data record creation and transfer according to an embodiment of the present invention.

FIG. 5 illustrates one or more cryptocurrency accrual pathways wherein users earn cryptocurrency for engagement with content.

One embodiment of the invention is implemented as a program product for use with a computer system. The program(s) of the program product defines functions of the embodiments (including the methods described herein) and may be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms used are interchangeable under appropriate circumstances such that the embodiments described herein are capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not limited to those elements, but may include other elements not expressly listed or inherent to such process, method, system, article, device, or apparatus.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

The present invention, in some embodiments, may comprise a decentralized electronic database distributed across various computers, or “nodes.” Full, lightweight (or simply “light”) nodes, client and submitting-client, peer, endorser, orderer, and/or ordering-service nodes are collectively referred to herein as “nodes” unless otherwise specified. The decentralized database may securely store and transmit data between computers, other electronic devices, and/or one or more nodes. The present invention may provide that when a new data record, such as a transaction, is created, it may link to the user's previous data record in the manner known in the block chain database art by using the storage information and chain-creation logarithms or instructions within the data record. By way of non-limiting example, the “genesis” block of a particular blockchain may contain a hash comprising its time and date of creation, at least one element of data (content, usage, rights data or cryptocurrency ownership) and a computer-solvable problem that, when solved, allows another block to link to the present block. Similarly, all other blocks on the blockchain in question may then comprise the previous block's hash, a hash comprising that block's time and date of creation, at least one element of data (content, usage, rights data or cryptocurrency ownership) and a computer-solvable problem that, when solved, allows another block to link to the present block.

In some embodiments, the present invention contemplates a separate blockchain for a cryptocurrency ledger that records cryptocurrency transfers and ownership data, content of all types (thereby ensuring the content's integrity), and content usage by users. In some embodiments, the present invention may process data from one type of blockchain (i.e. usage) and cause a change in one or more other blockchains (i.e. may record a related cryptocurrency transfer on the cryptocurrency ledger blockchain). In some embodiments, any blockchain may comprise any combination of data types. For example, a digital rights management tool may comprise a blockchain containing content, usage, and rights data within the data blocks. Or, in some embodiments, the digital rights management tool may comprise three separate blockchains for content, usage, and rights data. In some embodiments, the present invention may utilize one or more digital rights management tools and one or more cryptocurrency systems and ledgers in tandem or in combination.

By creating a linked series of immutable data records, the present invention may provide a secure chain of data records. As discussed more fully herein, the chain information may comprise one or more cryptographic hashes. For example, if the second data record contains the first data record's hash, the link between the two may be verified. By creating a new hash for each data record, and including that hash in the second data record, the present invention may provide for a traceable chain of data records.

The present invention may use real-world objects such as data matrix codes (or quick response “QR” codes) as private keys that “unlock” or decrypt a set of data when a user scans the QR code. A non-limiting application of this may be a physical “wallet” bearing a QR code that corresponds to a user's cryptocurrency account.

In some embodiments, a node may be any suitable electronic device, such as but not limited to a server, a mobile device, or desktop computer, that is linked to one or more networks provided by the present invention and that may perform the functions of the present invention, such as storing, linking block-to-block (“chaining” and thereby creating a link in a blockchain), encrypting, decrypting, and transmitting data. Each node may be configured to independently and automatically verify, update, link, and store each record.

The blockchain database of the present invention may utilize various cooperative or decentralized computing principles. In some embodiments, the blockchain database of the present invention may utilize principles or techniques drawn from cloud computing, thin-cloud computing, fog computing, or even “blockcloud” computing. The present invention may provide that the software, systems, methods, applications, computer programs, and so forth required to execute one or more instructions, methods, computer programs, or functions of the present invention may be stored on nodes, a cloud, thin cloud, fog, or blockcloud server structure.

The present invention may also provide for one or more interface elements, such as by way of illustration and not limitation, a desktop software program, a mobile application, or a website, that enables the user or, in some embodiments, a member of the public, to view one or more elements of a data record. By way of illustration and not limitation, a website may host an interface, wherein a login action could take a user to an individual's webpage. On the webpage, the present invention may describe or link to one or more elements of the individual's data record. By way of illustration and not limitation, such a page may contain a randomized identifier, the present data record's hash, a link to the data record's previous hash, and one or more links to one or more elements of user-specific data. In some embodiments, when viewed by a member of the general public, the webpage and the data record information may be hidden, randomized, or otherwise unreadable. Or in some embodiments, when viewed by a member of the general public, the webpage and the data record information may be deidentified but otherwise viewable. In some embodiments, when “unlocked” via the QR code, the data record may display unencrypted versions of the user-specific data, along with the hashes.

The present invention may comprise some elements of traditional block chain database encryption, storage, management, and access. The present invention may also make use of other, more widely-used technologies, such as cloud computing, emails, and text messages. The present invention may also draw upon, digitize, or otherwise incorporate paper documents in some embodiments.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

The present disclosure is directed to a system, method, and apparatus for online content platform and related cryptocurrency, wherein a proprietary cryptocurrency is provided to users based on their consumption of provided content, as well as for the consumption of content by persons they referred to the present invention.

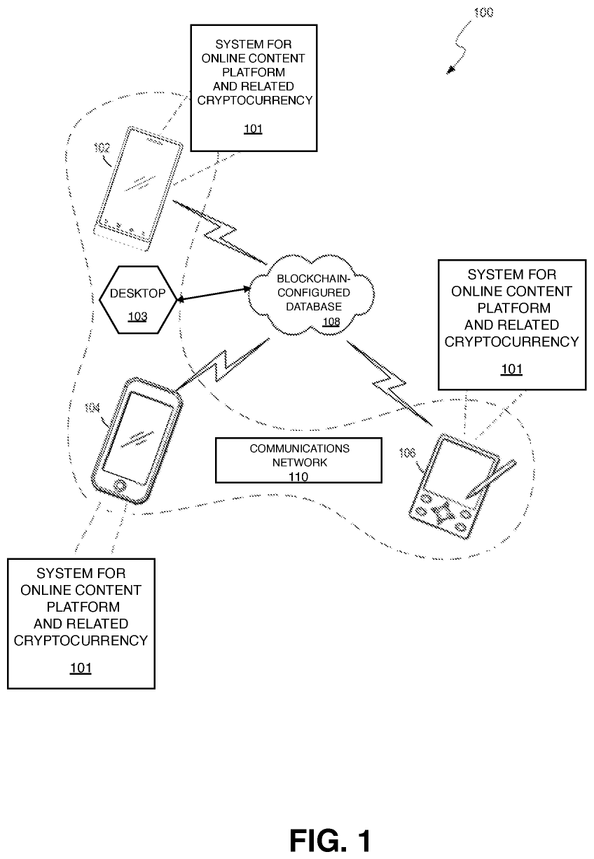

FIG. 1 illustrates an exemplary embodiment of a system, method, and apparatus for online content platform and related cryptocurrency 100 which includes a plurality of electronic devices communicatively coupled to one another. By way of example, and not limitation, FIG. 1 illustrates mobile devices 102, 104, and 106, and desktop computer 103 that incorporate a system for online content platform and related cryptocurrency 101 and may be communicatively coupled via a communications network 110 and blockchain-configured database 108. Each of the mobile devices 102, 104, and 106 may be embodied as a mobile computing device such as, for example and without limitation, a smartphone or tablet computer that incorporates cellular telephone functionality. Notably, the communications network 110 may use one or more of various communications types such as, for example and without limitation, short range device-to-device wireless data transfer (i.e Bluetooth), cellular, and Wi-Fi communications. In some embodiments, one or more nodes (not pictured) may take the place of one or more of mobile devices 102, 104, and 106, and desktop computer 103. Communications network 110 may serve to communicatively couple, link, or transfer data between one or more of mobile devices 102, 104, and 106, desktop computer 103, and any node with blockchain-configured database 108.

Users of desktop computer 103 and mobile devices 102, 104, and 106 may be users of at least one blockchain-configured database 108 known to those skilled in the art. For instance, as noted above, blockchain-configured database 108 may comprise a peer-to-peer network, a cloud-based computing network, a fog computing network, a blockcloud computing network, or any other blockchain-configured database 108 known in the art capable of secure or unsecure data transfer. In some embodiments, blockchain-configured database 108 may be facilitated by a website that may require a registration and login prior to use.

In one embodiment, a data record may be stored in multiple copies across blockchain-configured database 108 on one or more nodes. While not separately pictured, any of one or more of mobile devices 102, 104, and 106, and desktop computer 103 may serve as one or more nodes. In some embodiments, each node may contain and run the software, hardware, firmware, or any other component necessary, to run the present invention. More specifically, each node may provide for a computer system that may run the program of the present invention, create, store, and link (or “chain”) data records to other data records. Each node may also provide for computational power sufficient to perform hash functions, other one-way encryption functions, two-way encryption functions, public key encryption functions and programs, symmetric encryption and symmetric key encryption functions and programs, along with any other function that may be used or provided for by the present invention.

In brief, the original or “genesis” data record may comprise, at least, a hash that records a timestamp representing the data record's creation date and time (along with, in some embodiments, other information), encrypted user-specific data, and instructions for the linking of the second data record to the present data record. In some embodiments, the instructions may comprise a mathematical problem to be solved. In some embodiments, the present invention may provide that the solution is provided to one or more nodes in blockchain-configured database 108. In some embodiments, some or all of the nodes in blockchain-configured database 108 may be equally able to solve the instructions, and therefore some or all of the nodes may discover the solution at roughly the same time, thus ensuring uniformity of record-keeping across blockchain-configured database 108. Additional data records may be linked to the genesis data record, and may comprise a new timestamp hash unique to that data record, the previous data record's hash, encrypted updated user-specific data, and instructions for the next block as detailed elsewhere herein.

Blockchain-configured database 108 may also be configured to associate a data record, and user-specific data within the data record, with a QR code. In some embodiments, the QR code may be stored on any or several of desktop computer 103 and mobile devices 102, 104, and 106. In some embodiments, the QR code may be displayed on at least one of desktop computer 103 and mobile devices 102, 104, and 106. The QR code thus displayed may be scanned by at least one of desktop computer 103 and mobile devices 102, 104, and 106, or by a different scanning device such as a hand-held scanner configured to work with the present invention (not pictured).

In some embodiments, the present invention may provide that one or more of desktop computer 103 and mobile devices 102, 104, and 106 may serve as a first electronic device. In such a configuration, one or more of desktop computer 103 and/or mobile devices 102, 104, and 106 may be configured to display a QR code. The QR code may, in some embodiments, be used as a user's private key and may, when scanned from the display of the first electronic device, cause the present invention to unlock, decrypt, or otherwise permit access to one or more items of user-specific data.

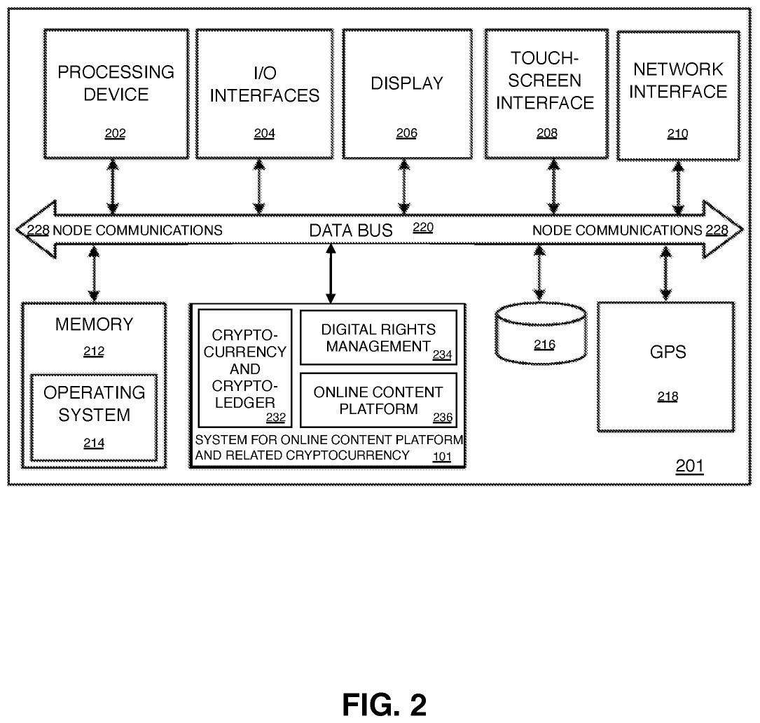

In the embodiment depicted in FIG. 2, node 201 may comprise, at least, at least one processing device (processor) 202, at least one input/output interface 204, at least one display 206, at least one user interface 208, at least one network interface 210, at least one memory 212, at least one operating system 214, at least one mass storage 216 and at least one GPS 218, with each communicating across a local data bus 220. FIG. 2 also discloses the relationship of local data bus 220, the cryptocurrency and cryptocurrency ledger 232 (“cryptocurrency data blocks”), the digital rights management tool 234, and the online content platform 236 of system for online content platform and related cryptocurrency 101. In some embodiments, node 201 may communicate with other node(s) 228 via one or more networks (not shown in FIG. 2). Additionally, an individual QR code (not pictured) may act as a private key that may enable one or more nodes 201 to access blockchain-encrypted data in an unencrypted or deidentified, or both, form.

As the present invention contemplated a distributed blockchain computer system wherein each node 201 may communicate with one or more nodes 201, and in some embodiments all other nodes 201, one or more elements of node 201 may be absent in any particular node 201 or shared across one or more nodes 201. In some embodiments, while it is contemplated that, generally although not required in every case, each node 201 may store a copy of all cryptocurrency data blocks 232 and their block-chains across the entire present invention, thereby creating a network of secure computing systems and thorough redundancy, one or more other elements may be partially stored on one or more nodes 201, or stored on one node 201 but accessed by another node 201. By way of illustration and not limitation, memory 212 and/or operating system 214 may be partially stored across several nodes 201 but accessed by multiple nodes 201, or may be stored on one or more nodes 201 and accessed by nodes 201 that do not have their own memory 212 and/or operating system 214.

The processing device 202 may include any custom made or commercially available processor, a central processing unit (CPU) or an auxiliary processor among several processors associated with node 201, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 212 may include any one of a combination of volatile memory elements (e.g., random-access memory (RAM, such as DRAM, and SRAM, etc.)) and nonvolatile memory elements. The memory typically comprises native operating system 214, one or more native applications, emulation systems, or emulated applications for any of a variety of operating systems and/or emulated hardware platforms, emulated operating systems, etc. For example, the applications may include application specific software which may comprise some or all the components of node 201. In accordance with such embodiments, the components are stored in memory and executed by the processing device. Note that although depicted separately in FIG. 2, the system, method, and apparatus for universally accessible personal medical records 100 may be resident in memory such as memory 212. As mentioned above, in some embodiments, one or more nodes 201 may not have their own memory 212 and/or operating system 214 or may store incomplete memory 212 and/or operating system 214, and may therefore draw upon other nodes 201 for use of one or more memory units 212 and/or operating system elements 214 via node 201 to node 201 communication 228, as discussed herein.

User interface 208 may be configured to detect contact within the display area of the display 206 and may provide such functionality as on-screen buttons, menus, keyboards, etc. that allows users to navigate user interfaces by touch. User interface 208 may also be a keyboard, a mouse, a microphone, a vision tracking system, a motion-capture system, a trackball, or any other known interface with a computing system. For some embodiments, node 201 may also comprise GPS 218 or other means to determine the location of the node 201.

One of ordinary skill in the art will appreciate that the operating system 214 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 2, network interface device 210 comprises various components used to transmit and/or receive data over a networked environment such as depicted in FIG. 1. When such components are embodied as an application, the one or more components may be stored on a non-transitory computer-readable medium and executed by the processing device.

In some embodiments, cryptocurrency data blocks 232 may be stored in one language, generally the user's native language. In some embodiments, however, the present invention may provide, through memory 212 or any other element of the present invention including elements known to the art but not disclosed in FIG. 2, that the cryptocurrency data blocks 232 may be translated into a selected language by the end user. For example, the present invention may provide that cryptocurrency data blocks 232 may be stored in English, but when accessed by a user, by using one or more of mobile device(s) 201, 104, 106 or desktop computer 103 to access cryptocurrency data blocks 232 via QR code, the cryptocurrency data blocks 232 may be translated into the language of the accessing device, here mobile device(s) 201, 104, 106 or desktop computer 103. This change may be automated in some embodiments, and may save users such as users valuable time.

Storage information for the blockchain elements of the present invention, which may encompass all the data for the present invention, as discussed in more detail herein, is generally managed as a series of links or “chains” between blocks, wherein each link to the chain requires a mathematical problem to be solved. Once a node 201 has reached the solution, the next block may be linked or chained to the present cryptocurrency data blocks block 232, thus creating the “blockchain” known in the art. Such chaining may comprise, in some embodiments, recording the hash of a first cryptocurrency data blocks 232 in or on a second cryptocurrency data blocks 232. In some embodiments, therefore, the chain may be traced by examining the corresponding hashes of each cryptocurrency data blocks 232 to make sure that they match as intended.

Continuing with FIG. 2, the genesis cryptocurrency data block 232 may provide for only one hash that may comprise a timestamp (at least) hash of its creation. For all other cryptocurrency data blocks 232, hash(s) may comprise a timestamp (at least) hash of the creation of the present cryptocurrency data block 232 as well as the hash of the previous cryptocurrency data block 232. Thereafter, each cryptocurrency data block 232 may comprise, at least, one or more hash(s), one or more items of cryptocurrency data, and one or more elements of storage information or chaining information. In some embodiments, an identical copy of each cryptocurrency data block 232 may be stored on one or more nodes 201. In some embodiments, an identical copy of each cryptocurrency data block 232 may be stored on each node 201.

In embodiments wherein content and content interaction information 234 (“content”) is stored in blockchain form, similarly, the genesis content block 234 may provide for only one hash that may comprise a timestamp (at least) hash of its creation. For all other content blocks 234, hash(s) may comprise a timestamp (at least) hash of the creation of the present content block 234 as well as the hash of the previous content block 234. Thereafter, each content block 234 may comprise, at least, one or more hash(s), one or more items of content data, and one or more elements of storage information or chaining information. In some embodiments, an identical copy of each content block 234 may be stored on one or more nodes 201. In some embodiments, an identical copy of each content block 234 may be stored on each node 201.

Remaining with FIG. 2, the present invention may be, and is contemplated generally to be, configured such that one or more nodes 201 may communicate with each other 228. The node 201 to node 201 communication system 228 provides for and enables one or more redundancy and/or data security protections of the present invention. Using node 201 to node 201 communication system 228, one or more nodes 201 of the present invention may all update one or more cryptocurrency data blocks 232 and cryptocurrency data block 232 chains, and content blocks 234 and content block 234 chains, hashes, copies of cryptocurrency data blocks 232 or content blocks 234, and any other element that the present invention may store on a node 201. One or more nodes 201 may utilize node 201 to node 201 communication system 228 to share one or more storage information 224, thereby enabling one or more nodes to chain a new cryptocurrency data blocks 232 to a previous cryptocurrency data block 232 or a new content block 234 to a precious content block 234. Additionally, one or more nodes 201 may utilize node 201 to node 201 communication system 228 to share one or more node 201 elements, such as but not limited to, part or all of a node's 201 at least one processing device (processor) 202, at least one input/output interface 204, at least one display 206, at least one user interface 208, at least one network interface 210, at least one memory 212, at least one operating system 214, at least one mass storage 216, at least one GPS 218, and/or at least one local data bus 232.

In some embodiments, a QR code may be used by the present invention as a private key. In some embodiments, when a user scans a user's QR code, such as by way of illustration by using one or more of mobile devices 201, 104, 106 and/or desktop computer 103, the present invention may provide one or more items of cryptocurrency data blocks 232 to the user in an unencrypted form, or a form having a mixture of encrypted and intelligible cryptocurrency data blocks 232 and/or content blocks 234. In some embodiments, the user may access the full cryptocurrency data blocks 232 or content blocks 234 and a fully unencrypted or fully intelligible record of the cryptocurrency data blocks 232 or content blocks 234. In some embodiments, only one QR code may be used at a time, and in some embodiments, only by the authorized user of mobile device(s) 201, 104, 106 or desktop computer 103 who initiated access via the QR code in the first place. In some embodiments, the user's QR code may be used by more than one mobile device 201, 104, 106 or desktop computer 103 at a time. It is contemplated that the user may be able to set preferences within the present invention, or utilize a secondary document such as a wallet card, to determine who or what may utilize the user's QR code, in what manner, and to what extent.

The present invention may provide that when a QR code is utilized to access a user's cryptocurrency data blocks 232 or content blocks 234, the present invention may create a new hash within a new cryptocurrency data block 232 or content block 234 that links to the accessed cryptocurrency data block 232 or content block 234 in the manner known in the block chain database art and generally described herein. By creating a linked series of chained cryptocurrency data blocks 232 or content blocks 234, it is contemplated that the present invention may provide a secure chain of data storage and data records.

In FIG. 2, data is shown progressing both directions between data bus 232 and cryptocurrency data blocks 232 or content blocks 234 through QR code or apart from QR code. In some embodiments, the role of QR code is one-directional, wherein a user via mobile device(s) 201, 104, 106 or desktop computer 103 may utilize QR code to access cryptocurrency data blocks 232, whereupon data bus 232 or any other element of node 201 may transfer one or more elements of cryptocurrency data blocks 232 from cryptocurrency data blocks 232 to the user's electronic device, such as but not limited to mobile device(s) 201, 104, 106 or desktop computer 103. In some embodiments, data may flow to the system for online content platform and related cryptocurrency 101 without QR code activation.

In order to facilitate the aforementioned functionality, various aspects may be performed by one or more of desktop computer 103 and/or mobile devices 201, 104, and 106, or any node 201 which may be but is not limited to desktop computer 103 and/or mobile devices 201, 104, and 106. In one embodiment, the desktop 103, mobile devices 102, 104, and 106, and/or any node 201 are operative to perform, at least in part, any method or system disclosed herein. Any of desktop 103, mobile devices 102, 104, and 106 may serve as a node 201 or carry out one or more node 201 functions.

Moreover, as discussed above, any element of content 234 may be stored on the present invention's blockchain database in the same manner as any cryptocurrency data block 232. In some embodiments, the present invention may provide that a user may use his or her QR code or other access element, such as a login on a webpage or to an application, to view one or more content 234 element. Moreover, each time content 234 is viewed or accessed, the present invention may update the blockchain for that particular content 234, per the block creation and chaining mechanisms detailed above. Content 234 and content block 234 may therefore be interchangeable, as each content 234 may be stored as a content block 234.

Additionally, cryptocurrency data blocks 232 and content 234 may interface. For example, were a user to purchase or rent a content 234 with cryptocurrency, both the particular content blocks 234 and cryptocurrency data blocks 232 may be updated accordingly. The present invention contemplates that any transaction involving content 234 and cryptocurrency data blocks 232 may be recorded in the appropriate block chain(s) and/or blockchain database.

Attention is now turned to one or more blockchain-related elements of the present invention. The blockchain paradigm provides a generalized framework for implementing decentralized computer resources. Each computing resource may be thought of as a singleton state-machine that may transition between states via cryptographically-secured transactions. When generating a new state-machine, the nodes encode logic which defines valid state transitions and uploads it onto the blockchain. From there on, the blocks may journal a series of valid transactions that, when incrementally executed with the state from the previous block, morph the state-machine into its current state. In a public chain, the Proof of Work consensus algorithm and its underlying peer-to-peer protocol secure the state-machines' process and transitioning logic from being tampered, and also share this information with all nodes participating in the system. Nodes may, therefore, query the state machines at any time and obtain a result which is accepted by the entire network with high certainty. This transaction-based state-machine generalization of the blockchain is informally referred to as smart contracts.

Ethereum is an example of an attempt at a full implementation of this idea. The present invention is not limited to Ethereum, and Ethereum is used herein merely as an illustrative and non-limiting embodiment. Any equivalent(s) or substitution(s) for Ethereum is/are contemplated. In its present form, Ethereum builds into the blockchain a Turing-complete instruction set to allow smart-contract programming and a storage capability to accommodate on-chain state. The flexibility of its programming language may be an important property in the context of rights management. This property may enable advanced functionality (multi-party arbitration, bidding, reputation, etc.) to be coded into the present system, adapting to comply with differences in regulation and changes in stakeholders needs. The present invention may utilize Ethereum's smart contracts to create intelligent representations of existing rights records that are stored within individual nodes on the network. The present invention may construct the contracts to contain metadata about the record ownership, permissions, and data integrity. The blockchain transactions in the present system may carry cryptographically signed instructions to manage these properties. The contract's state transition functions may carry out policies and enforce data alternation only by legitimate transactions. Such policies may be designed to implement any set of rules which govern a particular rights record, as long as the policy may be represented computationally. For example, a policy may enforce that separate transactions representing consent are sent from both artists and distributors before granting viewing permissions to a third party.

Cryptocurrencies may be generally thought of as digital currency systems that are run on a blockchain and utilize a blockchain financial ledger. The present invention's cryptocurrency is contemplated to exist as a coin or token that has an assigned value based on its purchase in a cryptocurrency marketplace of the present invention. The assigned value may change based on any number of factors, including but not limited to investor valuation, market conditions, supply, reserve, demand, exchange rates, and so forth.

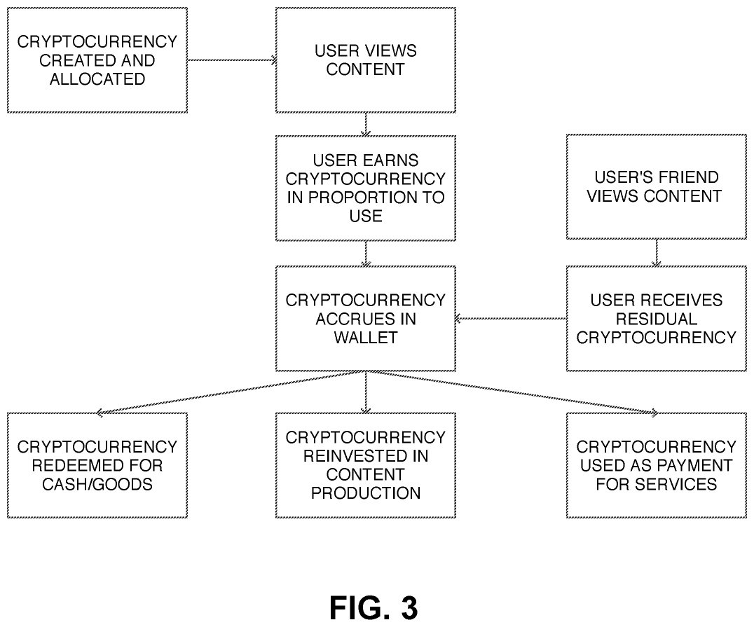

FIG. 3 generally discloses a flowchart depicting an exemplary embodiment of a method for online content platform and related cryptocurrency. In the embodiment shown, a cryptocurrency is firstly created and allocated 301. Then, a user may view the content 302 and earn cryptocurrency in proportion to their use 303. If a user's friend views content 304, the user may receive residual cryptocurrency 305 in proportion to the friend's use and the user's percentage allocation. Consequently, cryptocurrency accumulates in the user's wallet 306. The cryptocurrency may then be used at the user's option: the user may redeem cryptocurrency for cash or goods 307, the user may reinvest the cryptocurrency in content production 308, and the user may use the cryptocurrency as payment for services 309. Many other uses of the cryptocurrency are contemplated, such as but not limited to uses to which an advertiser or corporation may wish to put the cryptocurrency.

The system, method, and apparatus for online content platform and related cryptocurrency 100 may provide for a proprietary cryptocurrency configured to be utilized by the online content platform of the present invention. The cryptocurrency may be supported by a distributed online ledger stored according to blockchain computing principles across one or more nodes. In some embodiments, the cryptocurrency may be a token or token, or referred to as a coin or token. The users of the system, method, and apparatus for online content platform and related cryptocurrency 100 may earn cryptocurrency for his or her views of others' content on any device, from friends' views of any content (assuming the user referred the friend to the present invention), from views by friends-of-friends, and third-party views of the user's posted content. In some embodiments, a minimum amount of content interaction may be required, such as but not limited to watching two movies per week on the online content platform.

The users of the system, method, and apparatus for online content platform and related cryptocurrency 100 may be able to trade the cryptocurrency with other users or redeem the cryptocurrency for various benefits, such as a public credit or accolade, or in some embodiments, monetary currency or a real-world item or benefit. In some embodiments, a user may use the cryptocurrency to participate in movies or music videos by investing, and may in some embodiments trade the investments via the online content platform. A user may also in some embodiments use the cryptocurrency to purchase intellectual property rights of existing productions, or purchase products from the ecommerce wing of the online content platform.

To illustrate a sequence involving the present invention's cryptocurrency and cryptocurrency reward system, a three-user example may be instructive. In some embodiments, a first user may become a member of the present invention's network, and cryptocurrency for the first user may be allocated to the user 301. The first user also receives a wallet, and in some embodiments, a first installment of the present invention's cryptocurrency (or more simply, “cryptocurrency”). By becoming a member, the first user receives unlimited access to content, which enables the user to view content 302 such as watching movies or other content for free with advertising. The first user may also post social videos and images. The first user may also share videos (of any kind, including those made by the first user), image posts, Moments, movies, and other content with the first user's friends. By interacting with content, the first user gets paid cryptocurrency in proportion to the user's use of content 303, and cryptocurrency accrues in the user's wallet 305. The same process may occur for users designated as the user's friends when they view content 304. In the present invention however, the user may receive residual cryptocurrency allocations 305 based on the friend's usage of content 304. The cryptocurrency allocation percentage may in some embodiments depend on the manner and amount of advertising revenue generated by movies and other content, as well as by “moments” and friends' posts.

Once cryptocurrency has accrued in the user's wallet 305, the user may use the cryptocurrency in a number of ways, including but not limited to redeeming the cryptocurrency for cash or goods 307, reinvesting the cryptocurrency in content production 308, or using the cryptocurrency as payment for services 309. When the cryptocurrency is used to pay for services 309, for example, a content creator or other user may use the cryptocurrency to produce movies, music, video clips, sports events, or video games, or to pay actors, singers, models, crew members, and service distribution and production companies for services, to purchase intellectual property rights, or to purchase sponsorships, access to festivals, and entertainment events. Relatedly, a media advertiser may use the cryptocurrency in some embodiments, to purchase advertising, purchase partner services and items, build reputation and participation in wide groups, participate to partner events, participate in existing and future production of movies, music, and gaming projects, or buy digital and physical goods.

In some embodiments, the present invention may further provide for a digital or real wallet within which a user may store cryptocurrency or cryptocurrency-identifying information, such as a QR code. In some embodiments, a person may purchase the cryptocurrency with any real world or “hard” currency, such as but not limited to dollars or euros.

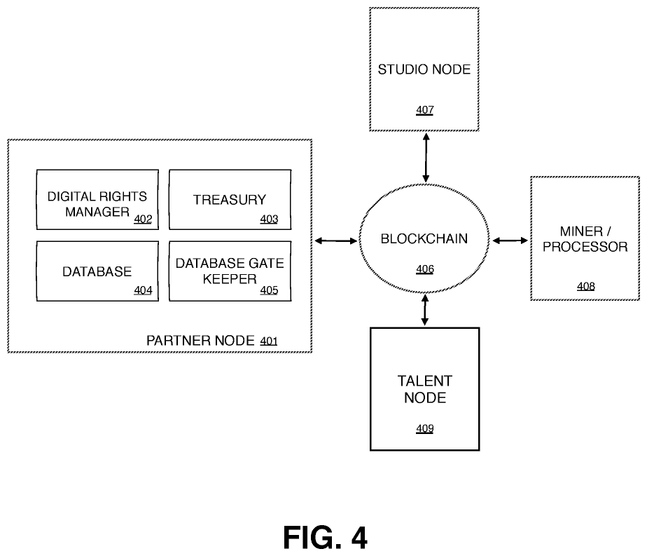

Turning attention to FIG. 4, as an initial matter, it should be noted that the Ethereum client component implements the full functionality required to join and participate in the Ethereum blockchain network. The Ethereum client handles a broad set of tasks, such as connecting to the peer-to-peer network, encoding and sending transactions and keeping a verified local copy of the blockchain. In some embodiments, the present invention may modify the Ethereum client to cause it to be aware of the present invention's mapping of identity and addresses. The present invention may then design and/or implement a service to locate the node's Abstract Contract, via Distributor, Artist and Studio Contract address lookup. This service may run continuously within the client to monitor real-time changes to the Abstract Contract. In the event of an update, the service may signal to the Digital Rights Manager and cause the Digital Rights Manager to issue a user notification and, if necessary, to sync the local database.

FIG. 4 generally illustrates one or more elements of data record creation and transfer according to an embodiment of the present invention, wherein Partner Node 401 comprises at least Digital Rights Manager 402, Treasury 403, Database 404, and Database Gate Keeper 405, and wherein the present invention's Blockchain 406 is in communication with Partner Node 401, Studio Node 407, Miner/Processor 408, and Talent Node 409.

In some embodiments, from the perspective of the backend, to add a new record, the example of a studio and talent record may be imagined. In such a non-limiting embodiment, the present invention may first, using the Distributor, Artist, and Studio Contracts tool on the blockchain 406, resolve the talent's identifying information to their matching Ethereum address and the corresponding Abstract Contract may be located. Next, the studio node 407 may upload a new Talent Administration Record (not shown) to the blockchain 406, indicating their stewardship of the data owned by the talent's Ethereum address. The studio node 407 may then craft a query to reference this data and update the Talent Administration Record accordingly. Finally, the partner node 401 sends a transaction which links the new Talent Administration Record to the talent's Distributor, Artist, and Studio Contract record, allowing the talent node 409 to locate it on the blockchain.

Remaining with FIG. 4, from the talent node 409 perspective, additional or alternative features may be perceived. In some embodiments, the talent's modified Ethereum client may continuously monitor the talent's Abstract Contract. Once a new block, such as by way of illustration and not limitation a newly linked Talent Administration Record, is processed/mined by Miner/Processor 408, the client may issue a signal via blockchain 406 which results in a user notification (not shown). The user may then acknowledge or decline the communication with the studio, after which the present invention may update the Abstract Contract on blockchain 406 accordingly. If the communication is accepted, an automated query request may be issued to any of partner node 401, studio node 407, talent node 409, or any node, obtain the new rights data. In some embodiments, the present invention may use the information in the new Talent Administration Record to locate the provider on the network and connect to Database Gate Keeper 405 server.

Relatedly, Database Gate Keeper 405 may implement an off-chain access interface to partner node's 401 local database, governed by permissions stored on blockchain 406. The Database Gate Keeper 405 may run a server listening to query requests from clients on the network. A request may contain a query string, as well as a reference to the Talent Administration Record on blockchain 406 that warrants permissions to run it. The request may be cryptographically signed by the issuer, allowing Database Gate Keeper 405 to confirm identities. Once the issuer's signature is certified, Database Gate Keeper 405 may check one or more contracts on blockchain 406 to verify if the address issuing the request is allowed access to the query. If the address checks out, Database Gate Keeper 405 may run the query on a local database for one or more of partner node 401, studio node 407, talent node 409, or any node, as appropriate, and return the result over to the client. Note that, in some embodiments, the present invention's components may similarly support third-parties retrieving talent-shared data: the talent selects data to share and updates the corresponding Talent Administration Record with the third-party address and query string, all via blockchain 406.

In some embodiments, Digital Rights Manager 402 may render data from local SQLite databases (designed to be interchangeable with other DB software) for viewing and present the users with update notifications, data sharing, and data retrieval options. The application may be accessed through a web interface, and in some embodiments may be built on a python backend framework. In some embodiments, the present invention may tie together one or more of the software components associated with the Digital Rights Manager 402 and a management interface application.

In some embodiments, the Digital Rights Management tool 402 may be a blockchain that may communicate with, and in some embodiments may be partially or entirely hosted and stored on, blockchain 406. It is contemplated that the Digital Rights Management tool 402 may interface with the online content platform, the cryptocurrency, and the cryptocurrency ledger. When embodied as a blockchain, Digital Rights Management tool 402 may record both the content of the present invention, as immutable copies of the content stored on one or more nodes, and data relating to the content.

Digital Rights Management tool 402 may store data such as contracts (i.e. traditional contracts, self-executing contracts, self-enforcing contracts, or smart contracts), usage histories, changes to cryptocurrency accounts, rights management and chain-of-title information, production and performance credits, content ownership and licensing deals (active and inactive), royalties paid and accrued, timestamp metadata relating to the content, and any other verifiable piece of information germane to the present invention. In some embodiments, Digital Rights Management tool 402 may comprise a blockchain, whereas in other embodiments Digital Rights Management tool 402 may be stored on a traditional computer server, hardware, or other backend element. Other types of contracts that may be created, stored, and accessed on the Digital Rights Management tool 402 include but are not limited to Distributor, Artist, and Studio Contracts, Talent Administration Record Contracts, Abstract Contracts, and other forms or types of contracts.

With respect to the Distributor, Artist, and Studio Contracts tool (not separately pictured), this global contract system may map participant identification strings to their Ethereum address identity (equivalent to a public key). In some embodiments, the present invention may use strings rather than the cryptographic public key identities directly, allowing the use of an already existing form of ID. Policies coded into the contract may regulate registering new identities or changing the mapping of existing ones. Identity registration may thus be restricted only to certified institutions. The Distributor, Artist, and Studio Contracts tool may also map identity strings to an address on the blockchain 406, where a special contract described below, called the Abstract Contract, may be found.

Talent Administration Record contracts (not separately pictured) may be issued between two participant nodes 401 when one node 401 stores and manages rights records for the other. While the present invention may use the case of Studio/Distributor and talent, this notion extends to any pairwise data stewardship interaction. The Talent Administration Record may define an assortment of data pointers and associated access permissions that identify the records held by the Studio/Distributor, or in some embodiments, any other person or entity. Each pointer consists of a query string that, when executed on the provider's database, returns a subset of talent data. The query string is affixed with the hash of this data subset, to guarantee that data have not been altered at the source. Additional information indicates where the provider's database may be accessed in the network, i.e. hostname and port in a standard network topology. The data queries and their associated information are crafted by the Studio/Distributor and modified when new records are added. To enable talent to share records with others, a dictionary implementation (hash table) maps viewers' addresses to a list of additional query strings. Each string may specify a portion of the talent's data to which the third-party viewer is allowed access. In a simple case, the provider references the talent's data with a simple SELECT query conditioned on the talent's equity card number.

For talent, the present invention may provide for a tool that allows the talent to check off fields they wish to share through the present invention's graphical interface. Under the hood, the system may formulate the appropriate SQL queries and upload them to the Talent Administration Record on the blockchain 406. Note that by using generic strings, the present invention's design may robustly interface with any string queried database implementation. Hence, it may conveniently integrate with existing Studio/Distributor data storage infrastructure. At the same time, talent is enabled fine-grained access control of their rights records, selecting virtually any portion of it they wish to share.

An Abstract Contract (not separately pictured), in some embodiments, may function as a breadcrumb trail for all participants in the system to locate their rights record history. The present invention may provide for one or more Abstract Contract per participant, one Abstract Contract per one or more participant, or one Abstract Contract for all participants. Each Abstract Contract holds a list of references to Distribution, Artists and Studio Relationship contracts (DASRs), representing all the participant's previous and current engagements with other nodes in the system. Studios, on the other hand, are likely to have preferences to the talent they serve and third-parties with whom their talent have approved data sharing. The present invention may accommodate this. The Distributor, Artist, and Studio Contracts tool persists in the distributed network, adding crucial backup and restore functionality. Talent may leave and rejoin the system multiple times, for arbitrary periods, and always regain access to their history by downloading the latest blockchain from the network. The Distributor, Artist, and Studio Contracts tool also implements functionality to enable user notifications. Each relationship may store a status variable: indicating such as but not limited to whether the relationship is newly established, awaiting pending updates, and has or has not acknowledged talent approval. Studios in the present invention's system may set the relationship status in their talents' Distributor, Artist, and Studio Contract record whenever they update records or as part of creating a new relationship. Accordingly, the talent may poll their Distributor, Artist, and Studio Contract record and be notified whenever a new relationship is suggested, or an update is available. Talent may accept, reject or delete relationships, deciding which records in their history they acknowledge. This ensures that accepting or rejecting relationships is done only by the talent. In some embodiments, to avoid notification spamming from malicious participants, only providers may update the status variable.

With respect to the Network Administration Nodes (NANs, not separately pictured), the present invention may provide that the design the components of the NANs integrates with existing industry infrastructure. If pertinent, the present invention may interface with other preexisting nodes, such as may exist in connection with particular studios and that already manage databases with rights data stored on servers with network connectivity. The present invention's design introduces or contains four software components: Backend Library, Ethereum Client, Database Gatekeeper and Rights Manager. These may be executed on servers, combining to create a coherent, distributed system.

Treasury 403, in some embodiments, may comprise one or more cryptocurrency ledgers and associated cryptocurrency ledger blocks and blockchains. In some embodiments, Treasury 403 may be responsible, in whole or in part, for coordinating or facilitating the distribution, allocation, reallocation, redemption, valuation, or other action with respect to one or more units of cryptocurrency.

Blockchain 406 may comprise one or more blocks of blockchained data. The data in one or more blocks of the one or more blockchains collectively called blockchain 406 may pertain to content, usage, rights and/or cryptocurrency transfer and ownership (collectively “cryptocurrency ownership,” which are generally contained in cryptocurrency ledger blocks). Each block may comprise any element known in blockchain databases, such as one or more hashes recording the time and creation associated with the previous block, one or more hashes recording the time and creation associated with the present block, one or more encrypted or unencrypted data elements, and one or more computer-solvable problems that, when solved, enable one or more nodes to connect (or “chain”) one or more blocks to the present block. With respect to any data element, including but not limited to cryptocurrency ledger blocks, each user, which in some embodiments may be a user, a user's friend, or a user's friend of a friend, may be associated with a separate blockchain within blockchain 406. By way of non-limiting example, each of a user, a user's friend, and a friend of a friend of a user may have their own cryptocurrency ledger blockchain recording their cryptocurrency ownership and cryptocurrency ownership record. As it is contemplated that residual payments of cryptocurrency may accompany certain content interactions, and indeed may be specified as a cryptocurrency transfer amount that comprises a predetermined amount of cryptocurrency per type of interaction with each content element. Blockchain 406 may record in one or more blockchains, such as but not limited to a cryptocurrency ledger, changes in cryptocurrency ownership related to changing cryptocurrency balances in various users' wallets.

For example, in some embodiments, a user's cryptocurrency ledger block records may be recorded or created by one or more blockchains of blockchain 406 as a first, second, and so forth cryptocurrency ledger block comprising a first cryptocurrency hash of the previous cryptocurrency ledger block, a second cryptocurrency hash at least comprising a time and date of creation associated with the second cryptocurrency ledger block, a cryptocurrency ownership record (in some embodiments a first, second, and so forth updated cryptocurrency ownership block, as necessary), and at least one computer system-implementable instruction for linking another cryptocurrency ledger block to the present cryptocurrency ledger block.

Similarly, blockchain 406 may record one or more first, second, and so forth friend of the user cryptocurrency ledger block, comprising a (for example, first) friend of the user cryptocurrency hash at least comprising a time and date of creation associated with the first friend of the user cryptocurrency ledger block, at least one friend of the user cryptocurrency ownership record, and at least one computer system-implementable instruction for linking a second friend of the user cryptocurrency ledger block to the first friend of the user cryptocurrency ledger block.

As well, blockchain 406 may record one or more first, second, and so forth friend of a friend of the user cryptocurrency ledger block, comprising a (for example, first) friend of a friend of the user cryptocurrency hash at least comprising a time and date of creation associated with the first friend of a friend of the user cryptocurrency ledger block, at least one friend of a friend of the user cryptocurrency ownership record, and at least one computer system-implementable instruction for linking a second friend of a friend of the user cryptocurrency ledger block to the first friend of a friend of the user cryptocurrency ledger block.

Cryptocurrency may be allocated and recorded in one amount to the appropriate cryptocurrency ledger block/blockchain in proportion to the content interacted-with by the user, friend of the user, or friend of the user that the user/friend of the user/friend of a friend of the user. In some embodiments, a different amount of cryptocurrency may be allocated to a user in proportion to the content interacted-with by the friend of the user and/or friend of the user. Such cryptocurrency allocations may be referred to as “derivative” cryptocurrency allocations at times herein.

Blockchain 406 may also create at least one (i.e. first, second, and so forth) content record block, comprising a (first, second, and so forth) content record hash at least comprising the previous content record block's time and date of creation, at least one content data element, at least one usage data element, and at least one computer system-implementable instruction for linking a second content record block to the first content record block. In some embodiments, the content record block may contain only the content data element, or may contain one or more content data element, usage data element, and/or rights data element.

Notably, any provider backend and user interface implementations may participate in the system by employing the modular interoperability protocol as defined through one or more blockchain contracts. One or more talent nodes 409 may contain the same basic components as providers or provider nodes. Implementation of talent nodes 409, and/or in some embodiments any nodes of the present invention, may be executed on a tablet, local computer and even a mobile phone. The talent nodes 409 or any node such as a participant node 401 or studio node 407 may provide for a local database that may be one of many lightweight database implementations. The databases may function merely as cache storage of the talent's rights data, or may store any other information. Missing data may be retrieved from the network at any time by following the node's Distributor, Artist, and Studio Contracts chain.

With respect to the Main Modular Software (MMS) and Treasury 403 Library API, the present invention may construct multiple utilities, bundled in a backend library, to facilitate the system's operation. The present invention's library may abstract the communications with the blockchain 406 and export a function-call API. Record management applications and their user interfaces may thus avoid the hurdles of working directly with blockchain 406. One such hurdle is verifying that each sent transaction is accepted with high confidence by the network. The backend library interacts with an Ethereum client to exercise the low-level formatting and parsing of the Ethereum protocol.

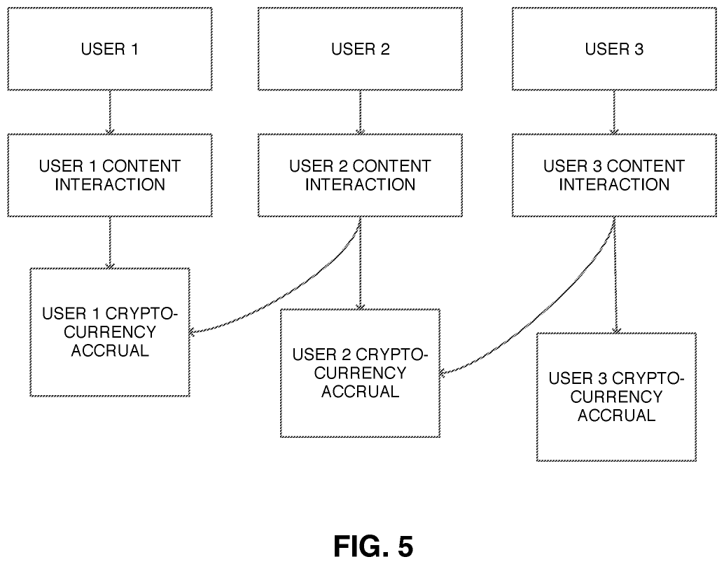

FIG. 5 illustrates one or more cryptocurrency accrual pathways wherein users earn cryptocurrency for engagement with content. In the embodiment shown, User 1 501, User 2 502 and User 3 503 are all users of the present invention. When User 1 interacts with content 504, User 1 accrues cryptocurrency 505. Similarly, when User 2 interacts with content 506, User 2 accrues cryptocurrency 507. As well, when User 3 interacts with content 508, User 3 accrues cryptocurrency 509. Moreover, in the embodiment shown and for purposes of illustration, User 2 502 is a friend of User 1 501, and User 3 503 is a friend of User 2 502.

It is contemplated that rate at which User 1 accrues cryptocurrency 505 from User 1's interactions with content 504, the rate at which User 2 accrues cryptocurrency 507 from User 2's interactions with content 506, and the rate at which User 3 accrues cryptocurrency 509 from User 3's interactions with content 508 may be any rate. Additionally, in some embodiments, the rate may vary based on a variety of factors, such as but not limited to the time, type, manner, and frequency at/with which a user may interact with content, or the ways in which the user shares or promotes content. Or, a series of fixed rates may apply based on any such factor. For example, User 1 501 (or any user) may accrue cryptocurrency 505 at a particular rate for the first five User 1 content interactions 504, at a second rate for the next five User 1 content interactions 504, at a third rate for the next five User 1 content interactions 504, and so forth, in any denomination.

As may be seen in FIG. 5, User 1 501, User 2 502 and User 3 503 each earn cryptocurrency for their own engagement with content. Additionally, the users may earn cryptocurrency for the content interactions of their friends. For example, User 1 501, as the most “upstream” user of the illustration, receives cryptocurrency from User 2's engagement with content 506, and in some embodiments (not shown in FIG. 5), from User 3's engagement with content 508 as well. The present invention may provide that User 1's cryptocurrency accrual 505 is a percentage of User 2's cryptocurrency accrual 507. In embodiments wherein User 1 501 earns a percentage of both User 2 cryptocurrency accrual 507 and User 3 cryptocurrency accrual 509, the present invention may provide that, in terms of the cryptocurrency diverted from User 3 503, User 1's cryptocurrency accrual 505 may exceed User 2's cryptocurrency accrual 507. Conversely, in terms of the cryptocurrency diverted from User 3 503, User 2's cryptocurrency accrual 507 may exceed User 1's cryptocurrency accrual 505.

Similar to the rates of accruing cryptocurrency from their own interactions with content, the percentages at which users earn residual cryptocurrency from other users designated as the user's friends may also vary. For example, the percentage at which User 1 accrues cryptocurrency 505 from User 2's interactions with content 506, or even User 3's interactions with content 508 (not shown in FIG. 5) may vary at any rate, as may the percentage at which User 2 accrues cryptocurrency 507 from User 3's interactions with content 508. Additionally, in some embodiments, the percentage may vary based on a variety of factors, such as but not limited to the time, type, manner, and frequency at/with which the friend of a user may interact with content, or the ways in which the friend of the user shares or promotes content. Or, a series of fixed rates may apply based on any such factor. For example, User 1 501 (or any user) may accrue cryptocurrency 505 at a particular rate for the first five User 2 content interactions 506, at a second rate for the next five User 2 content interactions 506, at a third rate for the next five User 2 content interactions 506, and so forth, in any denomination. Any number of users and cryptocurrency accrual or residual paths, including branched or broken paths, is contemplated by the present invention.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by any future claims.

Moreover, embodiments and limitations disclosed herein are not dedicated to the public under the doctrine of dedication if the embodiments and/or limitations: (1) are not expressly claimed in any future claims; and (2) are or are potentially equivalents of express elements and/or limitations in any future claims under the doctrine of equivalents.

### CONCLUSIONS, RAMIFICATIONS, AND SCOPE

While certain embodiments of the invention have been illustrated and described, various modifications are contemplated and may be made without departing from the spirit and scope of the invention. Accordingly, it is intended that the invention not be limited, except as by the appended claim(s).

The teachings disclosed herein may be applied to other systems, and may not necessarily be limited to any described herein. The elements and acts of the various embodiments described above may be combined to provide further embodiments. All of the above patents and applications and other references, including any that may be listed in accompanying filing papers, are incorporated herein by reference. Aspects of the invention may be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the present invention with which that terminology is associated. In general, the terms used in any future claims should not be constructed to limit the present invention to the specific embodiments disclosed in the specification unless the above description section explicitly define such terms. Accordingly, the actual scope encompasses not only the disclosed embodiments, but also all equivalent ways of practicing or implementing the disclosed present invention. The above description of embodiments of the present invention is not intended to be exhaustive or limited to the precise form disclosed above or to a particular field of usage.

While specific embodiments of, and examples for, the present invention are described above for illustrative purposes, various equivalent modifications are possible for which those skilled in the relevant art will recognize.

While certain aspects of the present invention are presented below in particular claim forms, various aspects of the present invention are contemplated in any number of claim forms. Thus, the inventor reserves the right to add additional claims after filing the application to pursue such additional claim forms for other aspects of the present invention.

What is claimed is:

1. A system for an online content platform and related cryptocurrency, comprising:
configuring, by a computing system, at least one blockchain-configured database distributed across a plurality of computer networking systems, wherein the plurality of computer networking systems comprises at least one node;
configuring, by the computing system, at least one digital rights management tool, wherein the digital rights management tool comprises a blockchain-configured database having, at least:
a) at least one content blockchain comprising at least two blockchained blocks of content data;
b) at least one usage blockchain comprising at least two blockchained blocks of usage data; and
c) at least one rights data blockchain comprising at least two blockchained blocks of rights data;
configuring, by the computing system, at least one cryptocurrency ledger, comprising, at least:
a) at least one unit of cryptocurrency;
b) at least one blockchain-configured cryptocurrency ledger having at least two blockchained blocks of cryptocurrency ownership data; and
c) at least one cryptocurrency wallet associated with at least one user;
configuring, by the computing system, at least one online content platform, wherein the at least one online content platform is configured to, at least:
a) receive at least one content selection, wherein the at least one content selection comprises a designation by a user of at least one content data block;
b) identify the content data block designated by the at least one content selection;
c) display the at least one content element of the at least one content selection on an electronic device associated with a user having at least one cryptowallet;
d) chain a first new block of usage data to a previous block of usage data, wherein the first new block of usage data records the display of the at least one content element on the electronic device associated with at least one user;
e) transfer at least one unit of cryptocurrency to the cryptowallet associated with at least one user; and
f) chain a first new block of cryptocurrency ownership data to a previous block of cryptocurrency ownership data, wherein the first new block of cryptocurrency ownership data records the transfer of the at least one unit of cryptocurrency to the cryptowallet associated with the user.

2. The system of claim 1, wherein the online content platform is further configured to:
a) receive at least one second content selection, wherein the at least one second content selection comprises a designation by a friend of the user of at least one content data block, wherein the friend of the user has at least one cryptowallet;
b) identify the content data block designated by the at least one second selection;
c) display the at least one content element of the at least one second content selection on an electronic device associated with the friend of the user;
d) chain a second new block of usage data to the first new block of usage data, wherein the second new block of usage data records the display of the at least one content element on the electronic device associated with the user;
e) transfer at least one unit of cryptocurrency to the cryptowallet associated with the user;
f) transfer at least one unit of cryptocurrency to the cryptowallet associated with the friend of the user; and
g) chain a second new block of cryptocurrency ownership data to the first new block of cryptocurrency ownership data, wherein the second new block of cryptocurrency ownership data records the transfer of the at least one unit of cryptocurrency to the cryptowallet associated with the user and the transfer of the at least one unit of cryptocurrency to the cryptowallet associated with the friend of the user.

3. The system of claim 2, wherein the online content platform is further configured to:
a) receive at least one third content selection, wherein the at least one third content selection comprises a designation by a friend of the friend of the user of at least one content data block, wherein the friend of the friend of the user has at least one cryptowallet;
b) identify the content data block designated by the at least one third selection;
c) display the at least one content element of the at least one third content selection on an electronic device associated with the friend of the friend of the user;
d) chain a third new block of usage data to the second new block of usage data, wherein the third new block of usage data records the display of the at least one content element on the electronic device associated with the friend of the friend of the user;
e) transfer at least one unit of cryptocurrency to the cryptowallet associated with the user;
f) transfer at least one unit of cryptocurrency to the cryptowallet associated with the friend of the user;
g) transfer at least one unit of cryptocurrency to the cryptowallet associated with the friend of the friend of the user; and
h) chain a third new block of cryptocurrency ownership data to the second new block of cryptocurrency ownership data, wherein the third new block of cryptocurrency ownership data records the transfer of the at least one unit of cryptocurrency to the cryptowallet associated with the user, the transfer of the at least one unit of cryptocurrency to the cryptowallet associated with the friend of the user, and the transfer of the at least one unit of cryptocurrency to the cryptowallet associated with the friend of the friend of the user.

4. The system of claim 3, wherein the friend of the friend of the user is a third party.

5. The system of claim 1, wherein the online content platform is further configured to run at least one advertising video on demand component, comprising:
a) a playback widget;
b) an internet interface application;
c) an advertising video on demand content management system; and
d) an advertising management and distribution network.

6. The system of claim 1, wherein the online content platform is further configured to run at least one social media and user management component, comprising:
a) a social widget;
b) a user management widget; and
c) an administration console.

7. A non-transitory, tangible computer-readable medium having stored thereon computer-executable instructions, which, when executed by a computer processor, enable one or more computers coupled to a network to execute a method for an online content platform and related cryptocurrency, the method comprising:
configuring, by a computing system, at least one blockchain-configured database distributed across a plurality of computer networking systems, wherein the plurality of computer networking systems comprises at least one node;
receiving, by the computing system, at least one content data element;
receiving, by the computing system, at least one usage data element;
creating, by the computing system, a first content record block, comprising:
a) a first content record hash at least comprising the first content record block's time and date of creation;
b) the at least one content data element;
c) the at least one usage data element;
d) at least one computer system-implementable instruction for linking a second content record block to the first content record block;
storing, by the computing system, the first content record block on at least one node;
creating, by the computing system, at least one unit of cryptocurrency;
creating, by the computing system, at least one cryptocurrency wallet associated with at least one user;
creating, by the computing system, at least one cryptocurrency ownership statement;
creating, by the computing system, a first cryptocurrency ledger block, comprising:
a) a first cryptocurrency hash at least comprising a time and date of creation associated with the first cryptocurrency ledger block;
b) at least one first cryptocurrency ownership record; and
c) at least one computer system-implementable instruction for linking a second cryptocurrency ledger block to the first cryptocurrency ledger block;
determining, by the computing system, at least one cryptocurrency transfer amount, wherein the at least one cryptocurrency transfer amount comprises a pairing of at least one unit of cryptocurrency with at least one content data element;
receiving, by the computing system, at least one content interaction request from at least one user, wherein the at least one content interaction request specifies at least one requested content record, wherein the at least one requested content record is a content data element;
facilitating, by the computing system, at least one content interaction between the at least one user and the at least one requested content record, wherein the at least one content interaction comprises providing the at least one content data element of the requested content record to an electronic device associated with the at least one user;
creating, by the computing system, a second usage data element comprising, at least, a memorialization of the at least one content interaction;
creating, by the computing system, a second content record block, comprising:
a) the first content record hash;
b) a second content record hash at least comprising the second content record block's time and date of creation;
c) the at least one content data record of the first content record block;
d) the second usage data element; and
e) at least one computer system-implementable instruction for linking a third content record block to the second content record block;
transferring, by the computing system, the at least one cryptocurrency transfer amount to the at least one cryptocurrency wallet associated with the at least one user;
updating, by the computing system, the first cryptocurrency ownership record into a first updated cryptocurrency ownership record, wherein the first updated cryptocurrency ownership record memorializes the at least one cryptocurrency transfer amount; and
creating, by the computing system, a second cryptocurrency ledger block, comprising:
a) the first cryptocurrency hash;
b) a second cryptocurrency hash at least comprising a time and date of creation associated with the second cryptocurrency ledger block;
c) the first updated cryptocurrency ownership record; and
d) at least one computer system-implementable instruction for linking a third cryptocurrency ledger block to the second cryptocurrency ledger block.

8. The computer-implemented method of claim 7, further comprising:
receiving, by the computing system, at least one second user content interaction request from at least one friend of the user, wherein the at least one second user content interaction request specifies at least one requested content record, wherein the at least one requested content record is a content record;
facilitating, by the computing system, at least one second user content interaction between the at least one friend of the user and the at least one requested content record, wherein the at least one second user content interaction comprises providing the at least one content element of the at least one requested content record to an electronic device associated with the at least one friend of the user;
creating, by the computing system, a third usage data element comprising, at least, a memorialization of the at least one second user content interaction;
creating, by the computing system, a third content record block, comprising:
a) the second content record hash;
b) a third content record hash at least comprising the third content record block's time and date of creation;
c) the at least one content data record of the first content record block;
d) the third usage data element; and
e) at least one computer system-implementable instruction for linking a fourth content record block to the third content record block;
transferring, by the computing system, at least one cryptocurrency transfer amount to the at least one cryptocurrency wallet associated with the at least one user;
creating, by the computing system, at least one second cryptocurrency ownership record that memorializes the at least one cryptocurrency transfer amount to the at least one cryptocurrency wallet associated with the at least one user;
transferring, by the computing system, at least one cryptocurrency transfer amount to the at least one cryptocurrency wallet associated with the at least one friend of the user;
creating, by the computing system, at least one first friend of the user cryptocurrency ownership record that memorializes the at least one cryptocurrency transfer amount to the at least one cryptocurrency wallet associated with the at least one friend of the user;
creating, by the computing system, at least one third cryptocurrency ledger block, comprising:
a) the second cryptocurrency hash;
b) a third cryptocurrency hash at least comprising a time and date of creation associated with the first user third cryptocurrency ledger block;
c) the at least one second cryptocurrency ownership record; and
d) at least one computer system-implementable instruction for linking a first user fourth cryptocurrency ledger block to the third cryptocurrency ledger block; and
creating, by the computing system, a first friend of the user cryptocurrency ledger block, comprising:
a) a first friend of the user cryptocurrency hash at least comprising a time and date of creation associated with the first friend of the user cryptocurrency ledger block;
b) the at least one first friend of the user cryptocurrency ownership record; and
c) at least one computer system-implementable instruction for linking a second friend of the user cryptocurrency ledger block to the first friend of the user cryptocurrency ledger block.

9. The method of claim 7, further comprising:
receiving, by the computing system, at least one third user content interaction request from at least one friend of a friend of the user, wherein the at least one third user content interaction request specifies at least one requested content record, wherein the at least one requested content record is a content record;
facilitating, by the computing system, at least one third user content interaction between the at least one friend of a friend of the user and the at least one requested content record, wherein the at least one third user content interaction comprises the at least one content element of the at least one requested content record to an electronic device associated with the at least one friend of a friend of the user;
creating, by the computing system, a fourth usage data element comprising, at least, a memorialization of the at least one third user content interaction;
creating, by the computing system, a fourth content record block, comprising:
a) the third content record hash
b) a fourth content record hash at least comprising the fourth content record's time and date of creation;
c) the at least one content data record of the first content record block;
d) the fourth usage data element; and
e) at least one computer system-implementable instruction for linking a fifth content record block to the fourth content record block;
transferring, by the computing system, at least one cryptocurrency transfer amount to the at least one cryptocurrency wallet associated with the at least one user;
transferring, by the computing system, at least one cryptocurrency transfer amount to the at least one cryptocurrency wallet associated with the at least one friend of the user;
transferring, by the computing system, at least one cryptocurrency transfer amount to at least one cryptocurrency wallet associated with the at least one friend of a friend of the user;
creating, by the computing system, at least one third cryptocurrency ownership record that memorializes the at least one cryptocurrency transfer amount to the at least one cryptocurrency wallet associated with the at least one user;
creating, by the computing system, at least one second friend of the user cryptocurrency ownership record that memorializes the at least one cryptocurrency transfer amount to the at least one cryptocurrency wallet associated with the at least one friend of the user;
creating, by the computing system, at least one first friend of a friend of the user cryptocurrency ownership record that memorializes the at least one cryptocurrency transfer amount to the at least one cryptocurrency wallet associated with the at least one friend of a friend of the user;
creating, by the computing system, a fourth cryptocurrency ledger block, comprising:
a) the third cryptocurrency hash;
b) a fourth cryptocurrency hash at least comprising a time and date of creation associated with the third cryptocurrency ledger block;
c) the third cryptocurrency ownership record; and
d) at least one computer system-implementable instruction for linking a fifth cryptocurrency ledger block to the fourth cryptocurrency ledger block;
creating, by the computing system, a second friend of the user cryptocurrency ledger block, comprising:
a) the first friend of the user cryptocurrency hash;
b) a second friend of the user cryptocurrency hash at least comprising a time and date of creation associated with the second friend of the user cryptocurrency ledger block;
d) the at least one second friend of the user cryptocurrency ownership record; and
e) at least one computer system-implementable instruction for linking a third friend of the user cryptocurrency ledger block to the second friend of the user cryptocurrency ledger block; and
creating, by the computing system, a first friend of a friend of the user cryptocurrency ledger block, comprising:
a) a first friend of a friend of the user cryptocurrency hash at least comprising a time and date of creation associated with the first friend of a friend of the user cryptocurrency ledger block;
b) the at least one first friend of a friend of the user cryptocurrency ownership record; and
c) at least one computer system-implementable instruction for linking a second friend of a friend of the user cryptocurrency ledger block to the first friend of a friend of the user cryptocurrency ledger block.

10. The method of claim 9, wherein the friend of the friend of the user is a third party.

11. The method of claim 7, further comprising running, by the computer system, at least one advertising video on demand component, comprising:
a) a playback widget;
b) an internet interface application;
c) an advertising video on demand content management system; and
d) an advertising management and distribution network.

12. The method of claim 7, further comprising running, by the computer system, at least one social media and user management component, comprising:
a) a social widget;
b) a user management widget; and
c) an administration console.

13. An apparatus for an online content platform and related cryptocurrency, comprising:
at least one computing system distributed across a decentralized electronic database, wherein the decentralized electronic database comprises at least one node, and wherein the at least one computing system is configured to:
configure at least one digital rights management tool, wherein the digital rights management tool comprises a blockchain-configured database having, at least:
a) at least one content blockchain comprising at least two blockchained blocks of content data;
b) at least one usage blockchain comprising at least two blockchained blocks of usage data; and
c) at least one rights data blockchain comprising at least two blockchained blocks of rights data;
configure at least one cryptocurrency ledger comprising, at least:
a) at least one unit of cryptocurrency;
b) at least one blockchain-configured cryptocurrency ledger having at least two blockchained blocks of cryptocurrency ownership data; and
c) at least one cryptocurrency wallet associated with at least one user;
configure at least one online content platform, wherein the at least one online content platform is configured to, at least:
a) receive at least one content selection, wherein the at least one content selection comprises a designation by a user of at least one content data block;
b) identify the content data block designated by the at least one content selection;
c) display the at least one content element of the at least one content selection on an electronic device associated with a user having at least one cryptowallet;
d) chain a first new block of usage data to a previous block of usage data, wherein the first new block of usage data records the display of the at least one content element on the electronic device associated with at least one user;
e) transfer at least one unit of cryptocurrency to the cryptowallet associated with at least one user; and
f) chain a first new block of cryptocurrency ownership data to a previous block of cryptocurrency ownership data, wherein the first new block of cryptocurrency ownership data records the transfer of the at least one unit of cryptocurrency to the cryptowallet associated with the user.

14. The apparatus of claim 13, wherein the online content platform is further configured to:
a) receive at least one second content selection, wherein the at least one second content selection comprises a designation by a friend of the user of at least one content data block, wherein the friend of the user has at least one cryptowallet;
b) identify the content data block designated by the at least one second selection;
c) display the at least one content element of the at least one second content selection on an electronic device associated with the friend of the user;
d) chain a second new block of usage data to the first new block of usage data, wherein the second new block of usage data records the display of the at least one content element on the electronic device associated with the user;
e) transfer at least one unit of cryptocurrency to the cryptowallet associated with the user;
f) transfer at least one unit of cryptocurrency to the cryptowallet associated with the friend of the user; and
g) chain a second new block of cryptocurrency ownership data to the first new block of cryptocurrency ownership data, wherein the second new block of cryptocurrency ownership data records the transfer of the at least one unit of cryptocurrency to the cryptowallet associated with the user and the transfer of the at least one unit of cryptocurrency to the cryptowallet associated with the friend of the user.

15. The apparatus of claim 14, wherein the online content platform is further configured to:
a) receive at least one third content selection, wherein the at least one third content selection comprises a designation by a friend of the friend of the user of at least one content data block, wherein the friend of the friend of the user has at least one cryptowallet;
b) identify the content data block designated by the at least one third selection;
c) display the at least one content element of the at least one third content selection on an electronic device associated with the friend of the friend of the user;
d) chain a third new block of usage data to the second new block of usage data, wherein the third new block of usage data records the display of the at least one content element on the electronic device associated with the friend of the friend of the user;
e) transfer at least one unit of cryptocurrency to the cryptowallet associated with the user;
f) transfer at least one unit of cryptocurrency to the cryptowallet associated with the friend of the user;
g) transfer at least one unit of cryptocurrency to the cryptowallet associated with the friend of the friend of the user; and
h) chain a third new block of cryptocurrency ownership data to the second new block of cryptocurrency ownership data, wherein the third new block of cryptocurrency ownership data records the transfer of the at least one unit of cryptocurrency to the cryptowallet associated with the user, the transfer of the at least one unit of cryptocurrency to the cryptowallet associated with the friend of the user, and the transfer of the at least one unit of cryptocurrency to the cryptowallet associated with the friend of the friend of the user.

16. The apparatus of claim 15, wherein the friend of the friend of the user is a third party.

17. The apparatus of claim 13, wherein the online content platform is further configured to run at least one advertising video on demand component, comprising:
a) a playback widget;
b) an internet interface application;
c) an advertising video on demand content management system; and
d) an advertising management and distribution network.

18. The apparatus of claim 13, wherein the online content platform is further configured to run at least one social media and user management component, comprising:
a) a social widget;
b) a user management widget; and
c) an administration console.
